(19) United States
(12) Patent Application Publication
(10) Pub. No.: US 2002/0055825 A1
(43) Pub. Date: May 9, 2002

(54) Method for generating and changing a parametric graphic design, application programing interface and CAD system

(75) Inventors: Yoshio Maeda, Aichi (JP); Hiroyuki Watanabe, Aichi (JP)

Correspondence Address: FINNEGAN, HENDERSON, FARABOW, GARRETT &, DUNNER LLP, 1300 I STREET, NW, WASHINGTON, DC, 20005, US

(73) Assignee: System Metrix Co., Ltd.

(21) Appl. No.: 09/774,611

(22) Filed: Feb. 1, 2001

(30) Foreign Application Priority Data
Mar. 31, 2000 (JP) 00-096011

(51) Int. Cl. G06F 9/45; G06F 17/50

(52) U.S. Cl. 703/1; 703/22

(57) ABSTRACT

The present invention provides an API that can be modified by a user using a parametric function of an automatic CAD system with a parametric function. The API passes information to the parametric engine of the auto-design CAD system and receives constrained conditions for a parametric graphic design described in a general script to pass it to the parametric engine. In other words, the API passes the information to the parametric engine of the auto-design CAD system and receives the information inputted from a sheet of a spreadsheet program to pass it to the parametric engine.

### BACKGROUND OF THE INVENTION

1. Field of the Invention

The present invention relates to a CAD (Computer Aided Design or Computer Aided Drafting) system. More particularly, the present invention relates to a CAD system having an automatic design CAD with a parametric function (a function for setting a constrained condition for a graphic design in advance and enabling a change or modification to the constrained condition). The invention also relates to a CAD system having an API (application programming interface) for helping an end user use the parametric function.

2. Description of the Related Art

A CAD system may include an automatic design function with a parametric function. In the conventional art, the end user of a CAD system orders a CAD system developing company, called a developer, to generate a graphic design. The developer delivers the graphic design with a developing cost after some time, and the user utilizes it. FIG. 10 shows a typical parametric graphic design. The parametric graphic design of FIG. 10 illustrates a spanner. In order to change the measure of a spanner, it is necessary not to change the angles. Therefore, there is a certain constrained condition (the angles) in this graphic design.

With reference to FIG. 9 the conventional CAD system will be explained. As shown in FIG. 9, after generating the graphic design (step 710), many procedures in an interactive mode, such as “addition and edit of a constrained condition in the interactive mode” (step 720), “definition of a parametric variable value in the interactive mode” (step 730), “evaluation of a parametric in the interactive mode” (step 740), and “generation of a parametric graphic design in the interactive mode” (step 750) follow. Here, the interactive mode is one method for realizing an interface between a program and an operator (a user). In the interactive mode, the program asks the user a question and urges the user to input the answer. Then, the user answers the question, and data necessary for the program can be obtained. Because many procedures of FIG. 9 are executed by the interactive mode, it is understandable that a developer of this CAD system makes the program comprising a user interface portion.

In the conventional CAD system, which is ordered to the developer, it is possible for an end user to change the measure or the like within the area that is estimated at the time of order. However, over time, there is a possibility that the ordered CAD system does not meet the actual conditions and the changeable area estimated at the time of ordering becomes insufficient. For example, in the case of a CAD system of an architectural design, components for an interior may be renewed and the shapes thereof may change. Further, in the case of a CAD of a desk in an office, cable outlets may be added or deleted and shapes thereof may change.

In the above case, because the end user cannot modify the program developed by the developer, the end user must ask the developer to re-create the program. Otherwise, in the case of minor changes, the end user finally modifies the graphic design generated by the automatic CAD system.

### SUMMARY OF THE INVENTION

The inventor of the present invention recognized that it is desirable for the end user to directly modify the graphic design. The end user should be able to directly define the shape of parametric components (components which can be laid out choosing the size at the time of calling out one of the generated components). Also, the inventor recognized that the conditions and the rules were inevitable regarding how to combine the parametric components defined in this way and other fixed components in order to expand it as a graphic design.

In order to realize the above, the invention provides an API (application programming interface) suitable for a parametric system to describe the rules in a general script. The end user with knowledge of the script may thus directly modify the graphic design.

An object of the present invention is to provide the end user with an API that can be modified with respect to a parametric function of the auto-design CAD system having a parametric function.

Another object of the present invention is to provide an API that passes information to a parametric engine of the auto-design CAD system and receives the constrained conditions for a parametric graphic design described in a general script to pass it to the parametric engine. The API of the present invention thus passes information to the parametric engine of the auto-design CAD system and receives information inputted from a sheet of a spreadsheet program to pass it to the parametric engine.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate an embodiment of the invention and, together with the description, serve to explain the principles of the invention. In the drawings,

FIG. 1 is a schematic diagram showing a general purpose computer according to an embodiment of the present invention;

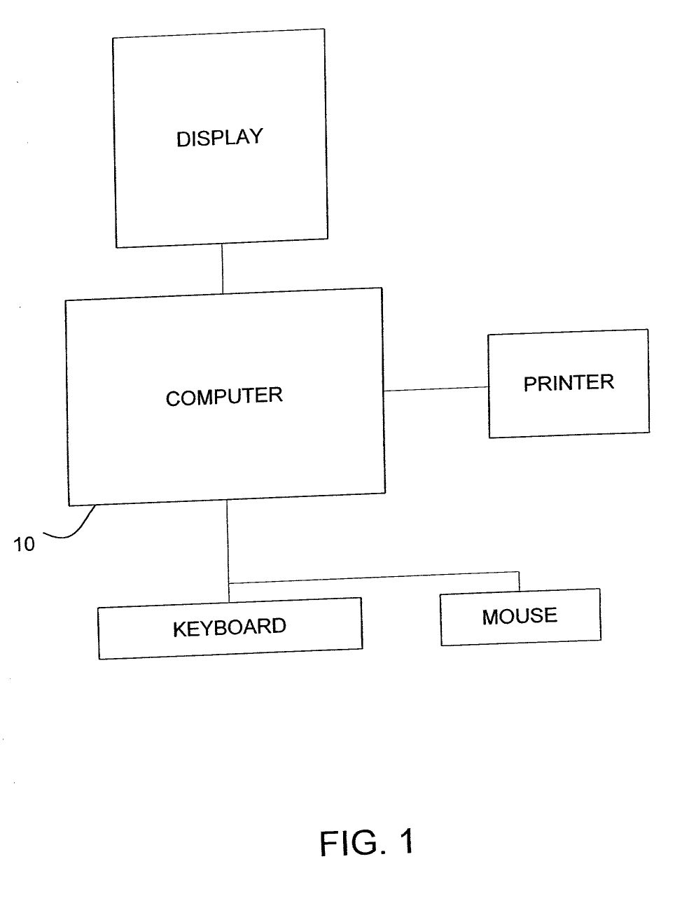

FIG. 2 is a flowchart for showing a CAD system according to the embodiment of present invention;

FIG. 3 is a flowchart showing addition and edit of constrained conditions by a script;

FIG. 4 shows a flow of addition and edit of constrained conditions by the script;

FIG. 5 shows a flow of addition and edit of the constrained conditions by the script using an application such as a spreadsheet program;

FIG. 6 is a flowchart of a process for converting data and sending the converted data to a DLL;

FIG. 7 shows a sample of addition of the constrained conditions;

FIG. 8 shows an insert sample using a DLL;

FIG. 9 is a flowchart for showing a conventional art; and

FIG. 10 shows a typical example of a parametric graphic design (illustrating a spanner).

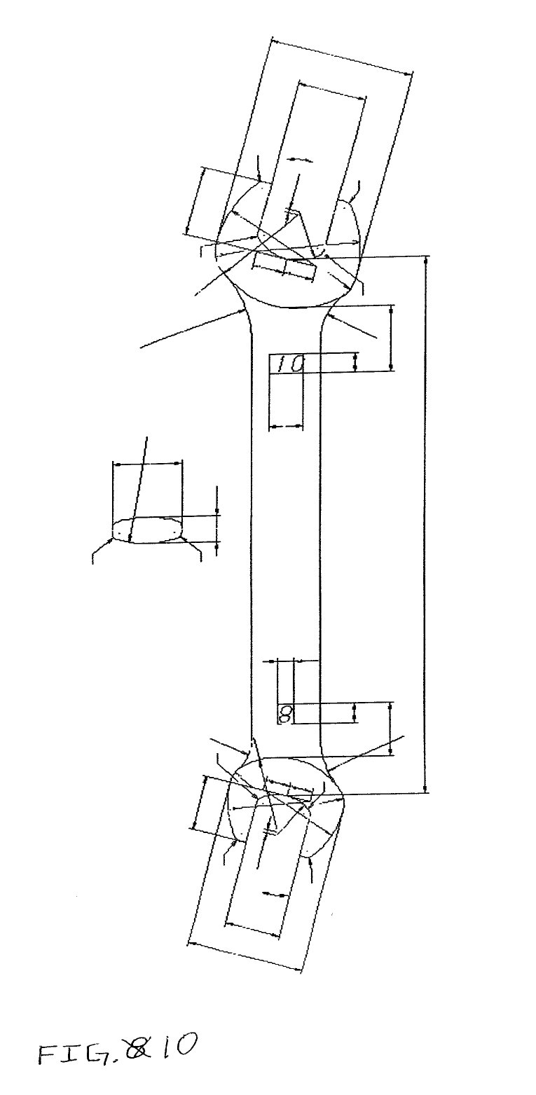

### DESCRIPTION OF THE PREFERRED EMBODIMENTS

An embodiment of the present invention will be explained below with reference to the attached drawings.

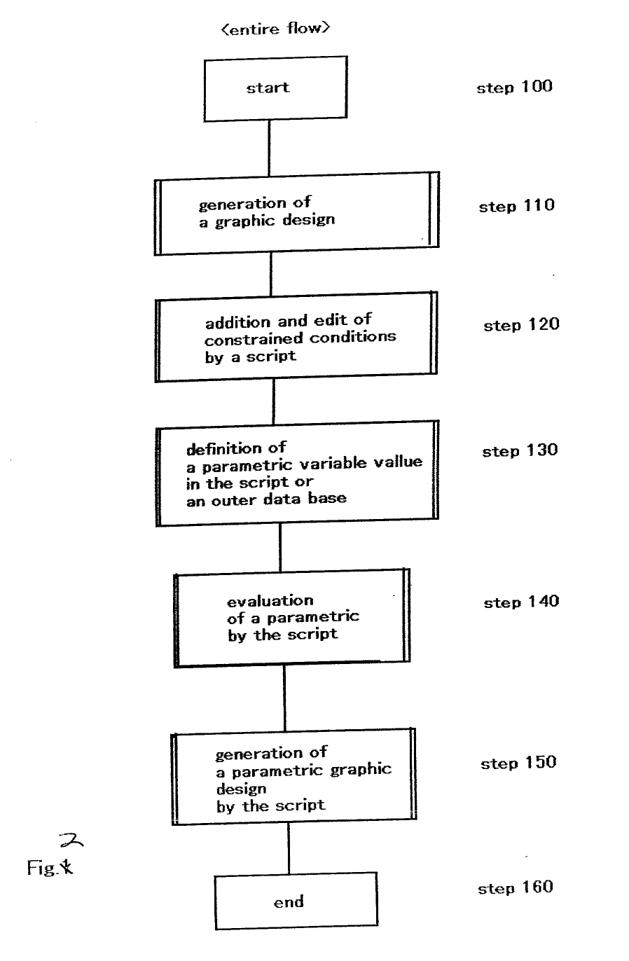

FIG. 2 is a flowchart showing an entire CAD system of the present invention. This program, for example, is a CAD system that can be constructed as an application running on a general OS using a general purpose computer 10. The program may be stored on, for example, a hard disk drive of the computer 10 or on a portable storage medium such as a floppy disk or an optical disk. Further, this CAD system is an auto-design CAD system having a parametric function as described in the “Description of the Related Art”.

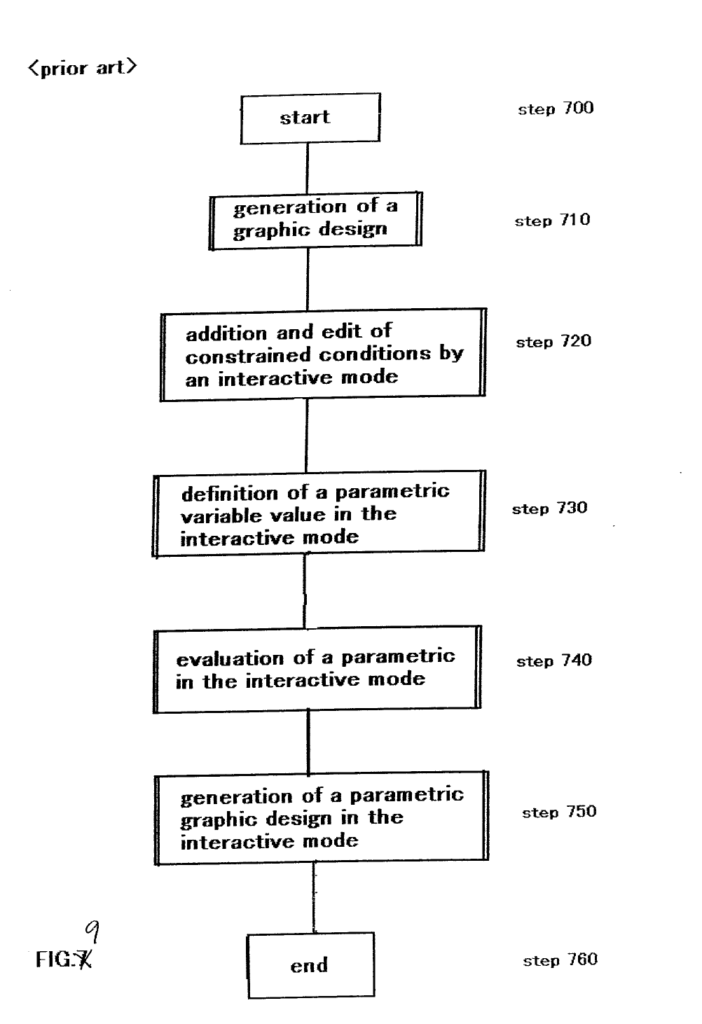

In FIG. 2, “generation of a graphic design” (step 110) is the same as step 710 in FIG. 9, showing the conventional art and the graphic design generated by an ordinary drawing function.

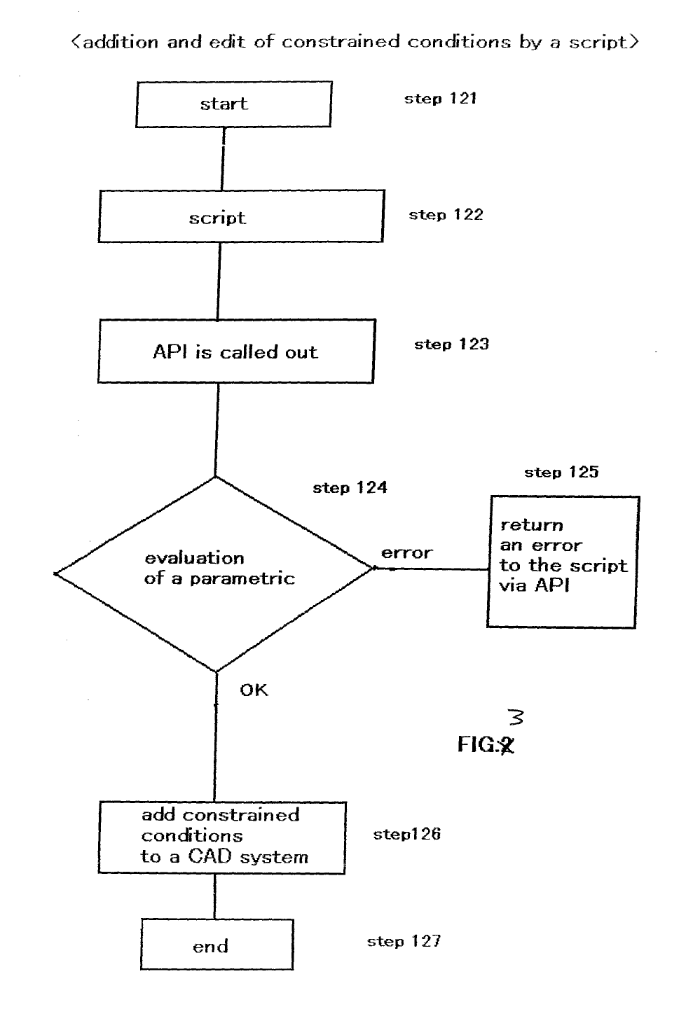

In FIG. 2, “addition and edit of constrained conditions by a script” (step 120) is an important portion and will be described in detail later with reference to FIG. 3. If step 120 is understood, the contents of steps 130, 140, and 150 can be easily understood. As “outer database” in step 130, for example, the data base function of a spreadsheet program such as EXCEL (a trademark of Microsoft Co., Ltd.) can be employed. The EXCEL program has a VBA (Visual Basic Application Edition), and the setting conditions such as an upper bound and a lower bound of a parameter setting value to a parametric modification can be incorporated via the VBA.

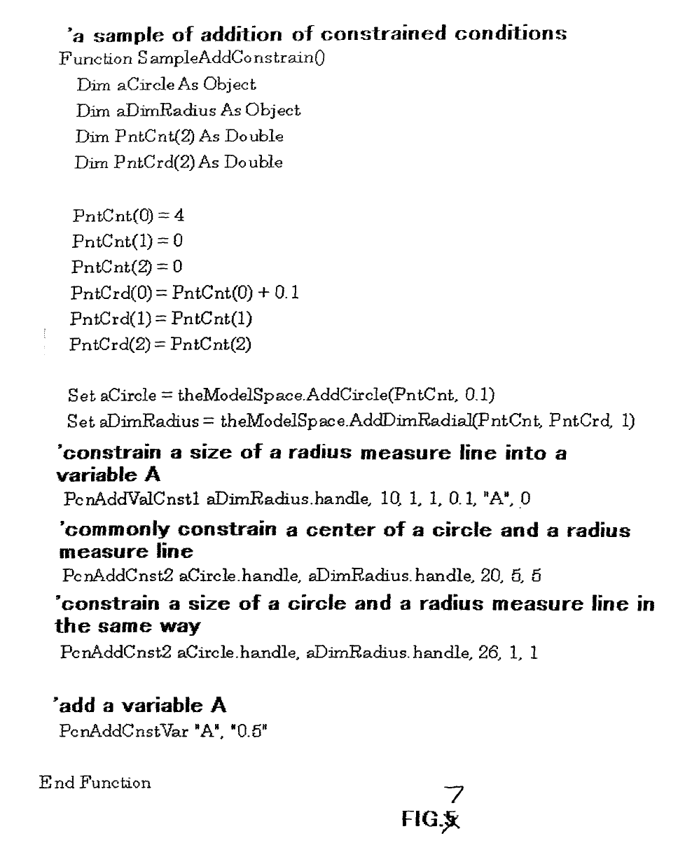

FIG. 3 is a flowchart of addition and edit to the constrained conditions using the script. The user describes an addition to the constrained conditions using the script (step 122). An example is shown in FIG. 7. FIG. 7 is a sample of an addition to the constrained conditions. In FIG. 7, “constrain the size of a diameter measure line into a variable A”, “commonly constrain a center of a circle and a diameter measure line”, “constrain a size of a circle and a diameter measure line in the same way”, “add a variable A”, or the like comprise the constrained conditions in order to change the diameter measure line appropriately even when changing the measure of a circle.

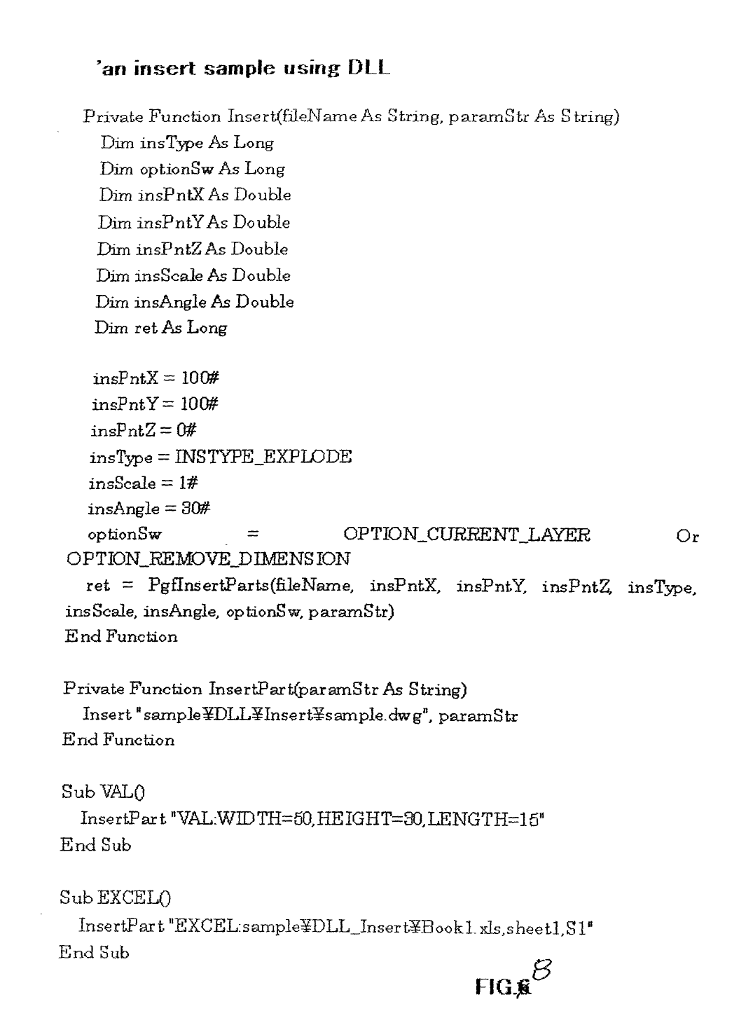

By the script description of step 122, an API (application programming interface) is called out. The API converts the script and passes the converted script to a DLL. Here, DLL means dynamic link library, a common program for linking upon execution. FIG. 8 shows an insert sample using DLL. A parametric engine in the DLL evaluates whether the constrained conditions have contradictions or not (step 124). If they do not have contradictions, the constrained conditions are added to a database of a CAD system and are registered (step 126). If errors are found, the constrained conditions are returned to the script via the API (step 125). This is a flow of addition and edit of the constrained conditions by the script.

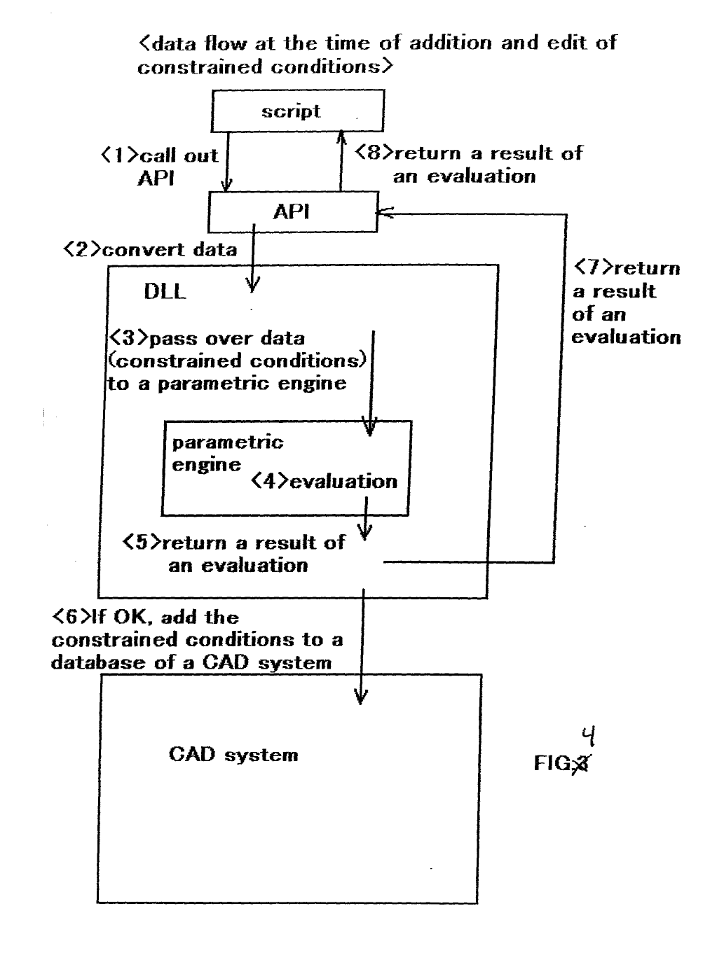

FIG. 4 shows structurally a data flow of addition and edit of constrained conditions The API is located between the script and the DLL. A parametric engine is located inside of the DLL. After the evaluation of the constrained conditions by the parametric engine, if the result is without error (OK), then the constrained conditions are registered to the database of a CAD system. The explanation is given with reference to a flow of data. A script calls out the API (<1>); the API converts the data and passes the converted data to the DLL (<2>); the DLL passes the data (constrained conditions) to a parametric engine (<3>); the parametric engine evaluates the data (<4>); and the parametric engine returns the result to the DLL (<5>). If the result is OK, the DLL adds the constrained conditions to the database of the CAD system (<6>); the DLL returns the result of the evaluation to the API (<7>); and the API returns the result of the evaluation to the script (<8>). The data flow is as mentioned above.

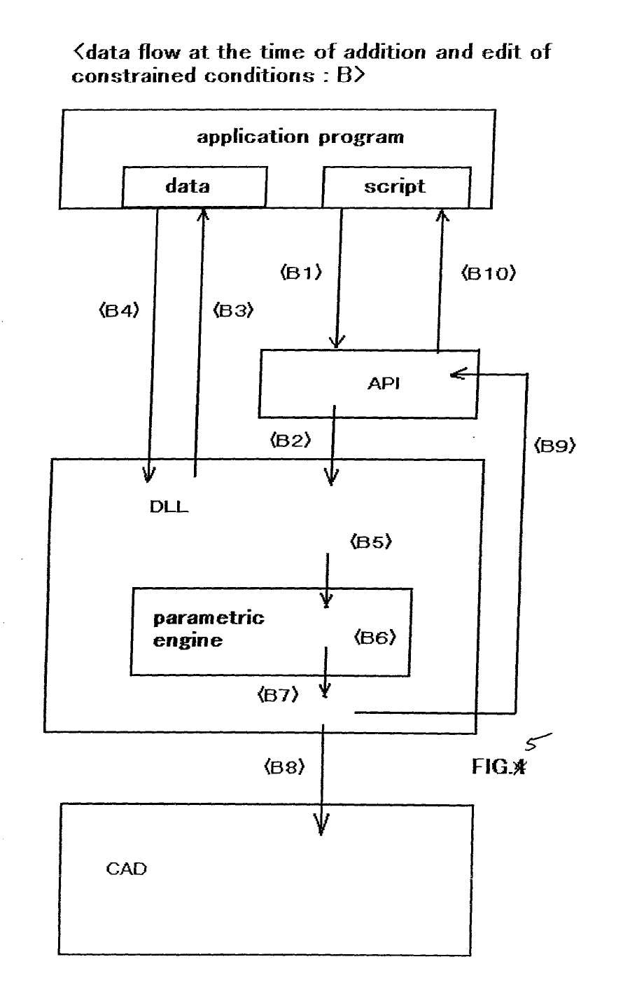

FIG. 5 shows a data flow in the case of using an outer database such as EXCEL. When a VBA such as EXCEL is employed and the user inputs the constrained conditions from a work sheet (a spreadsheet), the same thing as the description by the script can be achieved. The data flow is explained with respect to a data flow diagram. A script inside of the application (for example, EXCEL) calls up the API (<B1>); the API converts the data and passes the converted data to the DLL (<B2>); the DLL demands the data acquisition to the application (<B3>); the application returns the data to DLL (<B4>); and DLL passes over the data (variable value) for constrained conditions to a parametric engine (<B5>). Then, the parametric engine evaluates the data (<B6>) and the parametric engine returns the result to the DLL (<B7>). If the result is OK, the DLL generates a graphic design on a CAD system (<B8>); the DLL returns the result to the API (<B9>); and the API returns the result to the script (inside of the application) (<B10>). The state above explains the data flow.

EXCEL, which is mentioned above, is one example of spreadsheet software, and the other software can be utilized in the same way as EXCEL.

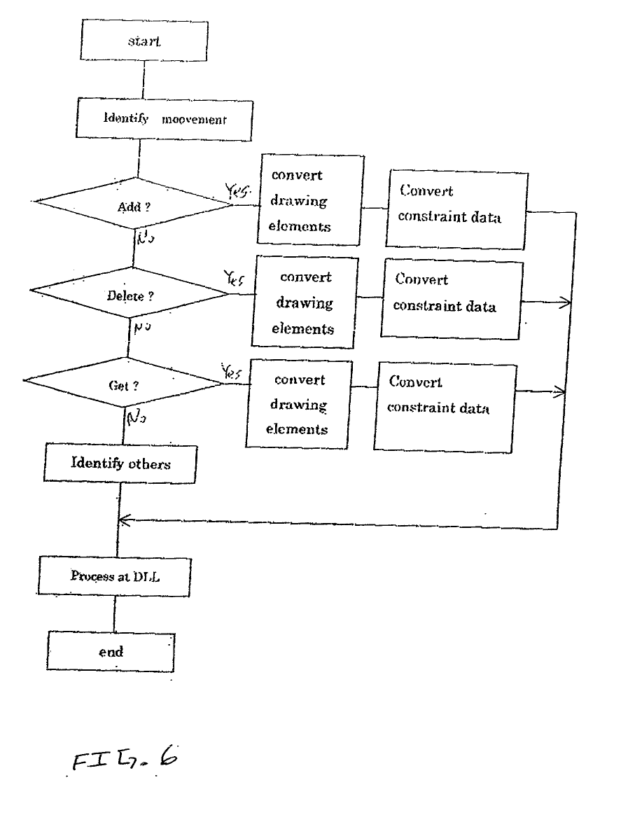

FIG. 6 shows a flow chart of the data conversion and the sending of converted data to the DLL. Three categories of data from the API script may be converted, movement data, drawing data, and constraint data. Movement, or dynamic change, data comprises add constraint, delete constraint, and get constraint. Other movements do not require drawing element identifications or constraint data such as evaluation, adding valuables, or deleting valuables. The drawing element identification distinguishes the drawing elements. Constraint data type designates constraints such as parallel or same size. Constraint data attributes describes the constraint data such as the constraint data size or variability. When the movement involves constraint data, this constraint data does not have to be sent because the system already knows the constraint conditions.

Other embodiments of the invention will be apparent to those skilled in the art from consideration of the specification and practice of the invention disclosed herein. It is intended that the specification and examples be considered as exemplary only, with the true scope and spirit of the invention being indicated by the following claims.

What is claimed is:

1. A method performed by a computer for generating and changing a parametric graphic design in a computer aided design or drafting system having a parametric function, the method comprising the steps of:
receiving a constrained condition of the parametric graphic design;
describing the constrained condition in a general script;
passing the general script to an application program interface associated with a parametric engine; and
operating the parametric engine according to the general script passed to the application program interface.

2. The method as claimed in claim 1, further comprising the step of editing the general script before passing the edited general script to the application program interface.

3. The method as claimed in claim 1, further comprising the step of converting the general script in the application program interface before passing the converted general script to the parametric engine, the parametric engine recognizing and executing the converted general script.

4. The method as claimed in claim 3, further comprising the step of checking the converted general script, in the parametric engine, for contradictions in the constrained conditions.

5. The method as claimed in claim 4, further comprising the step of, if the constrained conditions do not contain contradictions, adding the constrained conditions to a database of the computer aided design or drafting system.

6. The method as claimed in claim 5, further comprising the step of, if the constrained conditions contain contradictions, repeating the step of describing the constrained condition in a general script.

7. A method performed by a computer for generating and changing a parametric graphic design in a computer aided design or drafting system having a parametric function, the method comprising the steps of:
expressing a constrained condition of the parametric graphic design as a worksheet of a spreadsheet program;
passing the worksheet to an application program interface associated with a parametric engine; and
operating the parametric engine according to the worksheet passed to the application program interface.

8. The method as claimed in claim 7, further comprising the step of editing the worksheet before passing the edited worksheet to the application program interface.

9. The method as claimed in claim 7, further comprising the step of converting the worksheet in the application program interface before passing the converted worksheet to the parametric engine, the parametric engine recognizing and executing the converted worksheet.

10. The method as claimed in claim 9, further comprising the step of checking the converted worksheet, in the parametric engine, for contradictions in the constrained conditions.

11. The method as claimed in claim 10, further comprising the step of, if the constrained conditions do not contain contradictions, adding the constrained conditions to a database of the computer aided design or drafting system.

12. The method as claimed in claim 11, further comprising the step of, if the constrained conditions contain contradictions, repeating the step of expressing a constrained condition of the parametric graphic design as a worksheet of a spreadsheet program.

13. A computer readable medium having contents for causing a computer based information handling system to perform steps for generating and changing a parametric graphic design in a computer aided design or drafting system having a parametric function, the steps comprising:
receiving a constrained condition of the parametric graphic design;
describing the constrained condition in a general script;
sending the general script to an application program interface and then converting the general script; and
sending the converted general script from the application program interface to a parametric engine and then recognizing and executing the converted general script.

14. The medium as claimed in claim 13, the steps further comprising editing the general script before passing the edited general script to the application program interface.

15. The medium as claimed in claim 13, the steps further comprising, in the parametric engine, checking the converted general script for contradictions in the constrained conditions.

16. The medium as claimed in claim 15, the steps further comprising, if the constrained conditions do not contain contradictions, adding the constrained conditions to a database of the computer aided design or drafting system.

17. The medium as claimed in claim 13, wherein the general script comprises a worksheet of a spreadsheet program.

18. The medium as claimed in claim 14, wherein the general script comprises a worksheet of a spreadsheet program.

19. The medium as claimed in claim 15, wherein the general script comprises a worksheet of a spreadsheet program.
